(19) United States
(12) Patent Application Publication
(10) Pub. No.: US 2006/0214142 A1
(43) Pub. Date: Sep. 28, 2006

(54) Flame retardant agent and flame-retardant resin composition

(75) Inventor: Susumu Nikkeshi, Shibata-gun (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Tohoku Ricoh Co., Ltd., Shibata-gun (JP)

(21) Appl. No.: 11/200,101

(22) Filed: Aug. 10, 2005

(30) Foreign Application Priority Data
Sep. 13, 2004 (JP) 2004-265912

(51) Int. Cl. C09K 21/00

(52) U.S. Cl. 252/601

(57) ABSTRACT

The object of the present invention is to provide a flame retardant agent which can provide with high flame retardance with a very small amount of additives without impairing basic physical properties of resins and is highly safe and harmless to humans and environment without substantially having negative effect thereon, because the flame retardant agent does not contain halogen elements and phosphorus elements. To this end, the invention provides a flame retardant agent which comprises a polyvalent phenol compound, a saccharide compound, and a fatty acid compound and also provides a flame-retardant resin composition which comprises the flame retardant agent and a resin.

### BACKGROUND OF THE INVENTION

1. Field of the Invention

The present invention relates to a flame retardant agent enabling imparting excellent flame retardance to resins and further relates to a flame-retardant resin composition which comprises the flame retardant agent.

2. Description of the Related Art

Resins used for component parts of home electric appliances and office automation equipment in the United States need to satisfy flame retardance by the UL-94 Flame Retardant Standard of Under Writers Laboratories Inc., Standard on a component part to component part basis. In recent years, the UL-94 Flame Retardant Standard has been increasingly employed not only in the U.S. but also in most countries including Japan.

It is considered that conventional flame retardant agents are typically based on the following three principles or techniques. They are used in accordance with individual applications and the type of resin.

A flame retardant agent according to the first principle which serves as a negative catalyst to burned flame and lowers burning rate by adding 10% by mass to 20% by mass of a halogen compound to a resin to thereby give the flame retardance to the resin.

A flame retardant agent according to the second principle in which a char layer is formed on a surface of a resin to form a heat insulation film to thereby stop burning of the resin by adding several percent by mass to several tens percent by mass of a silicone compound to the resin, or by adding several percent by mass to ten and several percent by mass of a phosphoric acid compound to the resin to make the silicone compound bleed on the surface of the resin during the burning, or by developing dehydrogenation in the resin.

A flame retardant agent according to the third principle in which 40 parts by mass to 110 parts by mass of a metallic hydroxide such as magnesium hydroxide and aluminum hydroxide are added to 100 parts by mass of a resin to cool the whole resin to stop burning the resin by cooling the resin by action of endothermic reaction when these compounds are resolved by combustion of the resin and latent heat of vaporization held by produced water.

However, when the resin is burned as waste in accordance with the first principle, it causes problems with occurrence of dioxin from the halogen compound, unless sufficient amount of oxygen and sufficient combustion temperature are given to the resin.

According to the second principle, in the case of a phosphoric acid ester compound, phosphoric acid contained in the burned ash could lead to water pollution through waste plastics. When a large amount of a silicone compound is added to a resin, intrinsic physical properties of the resin are changed, and this may lower the strength of the resin. According to the third principle, since a large amount of a metallic hydroxide should be added to a resin, the resin is hydrolyzed, resulting in extremely weak mechanical properties of the resin.

Then the inventors of the present invention proposed a flame retardant agent which is highly effective in thermal stability by adding a tannin compound in a thermoplastic resin, since the tannin compound supplements radicals produced in the resin, and the flame retardant agent is extremely effective as a flame retardant agent, in Japanese Patent (JP-B) Nos. 3046962, 3046963, 3046964, and Japanese Patent Application Laid-Open (JP-A) No. 2003-313411, respectively.

However, it is known that combustion of a resin causes a gas by decomposition of the resin, and the gas continuously reacts with oxygen in the air to thereby continue to burn the resin. It is still difficult to provide with an adequately satisfiable level of flame retardance just with improvement in stability of a resin by adding a tannin compound to a resin. Therefore, further improvements and developments of flame retardant agents are required.

### SUMMARY OF THE INVENTION

It is therefore an object of the present invention to provide a flame retardant agent which can impart high flame retardance with a very small amount of additives without impairing basic physical properties of resins and is highly safe without negatively affecting the environment and human organisms because no halogen elements and phosphorus elements are included therein. Another object of the present invention is to provide a flame-retardant resin composition which comprises the flame retardant agent.

Keen examinations repeatedly provided by the inventor of the present invention to resolve the problems, the inventor found that a flame retardant agent which comprises a polyvalent phenol compound, a saccharide compound, and a fatty acid compound exhibits high thermal stability effect to resins as well as can reduce flammable gas generated during combustion of resins and effectively enables preventing resins from burning by suppressing formations of hydrocarbons generated by a thermal decomposition reaction.

In other words, a gas is generated by decomposing the resin, and the gas continuously reacts with oxygen in the air to thereby continue to burn the resin. In this case, when a fatty acid compound is present in a resin, the fatty acid compound discharges a gas which is hard to burn such as a benzoic acid into the burning gas during the thermal decomposition of the resin. When a saccharide compound is present in a resin, hydroxyl groups of the saccharide compound evoke a dehydration reaction in the resin in high temperatures due to combustion of the resin to discharge water from the resin and exert cooling effect on the resin as well as produce a charred layer on the surface to serve as a heat insulation film. A polyvalent phenol compound has high thermal stability because it supplements radicals formed in resins.

Thus, by adding a flame retardant agent which comprises a polyvalent phenol compound, a saccharide compound, and a fatty acid compound to a resin, it is possible to provide with excellent flame retardance satisfying the UL-94 Flame Retardant Standard. In addition, these compounds do not adversely affect changes in physical properties of resins because these compounds respectively have a sufficient effect with a small amount of addition. The inventors also found that it is possible to provide a highly safe flame retardant agent because polyvalent phenol compounds and saccharide compounds are ones that exist in nature and are harmless to humans and environment with no halogen elements and phosphorus elements contained therein.

The present invention is based on the findings of investigations by the inventors. The methods to resolve the problems are as follows.

A flame retardant agent according to the present invention comprises a polyvalent phenol compound, a saccharide compound, and a fatty acid compound.

A flame-retardant resin composition according to the present invention comprises a resin and the flame retardant agent of the present invention.

### BRIEF DESCRIPTION OF THE DRAWINGS

FIG. 1 is a graph showing the relationship between the added amount of the flame retardant agent according to Example 4 and the combustion time.

### DESCRIPTION OF THE PREFERRED EMBODIMENTS

(Flame Retardant Agent)

A flame retardant agent according to the present invention comprises a polyvalent phenol compound, a saccharide compound, and a fatty acid compound and further comprises other components in accordance with the necessity.

—Polyvalent Phenol Compound—

The polyvalent phenol compound is not particularly limited and may be suitably selected from those known in the art in accordance with the intended use. For example, tannin compounds are preferable from the perspective of its high thermal stability effect.

Examples of the tannin compounds include tannins, dehydration polycondensation reaction products of tannins; tannic acids such as tannic acid; catechins; leucoanthocyanes; and chlorogenic acids. Each of these may be used alone and in combination with two or more. These tannin compounds are widely contained in plant of nature. Such tannin compounds are categorized and described on page 98 in “Natural Product Chemistry” (Tennenbutsu Kagaku) written by Takao Murakami and Toshihiko Okamoto and published by Hirokawa Shoten in 1983. It is noted that tannic acids are referred to as tannins, and the present invention makes no distinction between tannic acids and tannins.

Tannin acids and catechins both of which are tannin compounds are categorized into two types, i.e. hydrolyzable tannins and condensed tannins, and there are a number of structurally different compounds of both tannin acids and catechins, because they are natural compounds.

Examples of the hydrolyzable tannins include Chinese tannin; ellagic tannin; and chlorogenic acids which comprises depside such as caffeic acids, and kinic acids.

Examples of the condensed tannins include quebracho tannin, Wattle tannin, gambier tannin, cutch tannin, and flubber tannin.

Chinese tannin is a product that gallic acids or derivatives thereof are ester-bound, and Chinese tannin is representative hydrolyzable tannin. Chinese tannin is represented by the following Structural Formula (1).

It is known that Chinese tannin has a structure in which ten gallic acid groups are located around a glucose residue, and two gallic acid groups are further bounded in a direction perpendicular to the glucose residue, i.e. the two gallic acid groups are located at the position marked with * or asterisk in the Structural Formula (1). However, the centrally positioned substance of Chinese tannin compounds is not necessarily limited to glucose, and it may be compounds in which cellulose is centrally positioned.

Didepside of gallic acids which is obtained by hydrolysis of tannic acids and represented by the following Structural Formula (2) can be also used.

As stated above, tannic acids are compounds widely contained in plant of nature, and thus it is easily possible to know by analogy that tannic acids have partially different chemical structures.

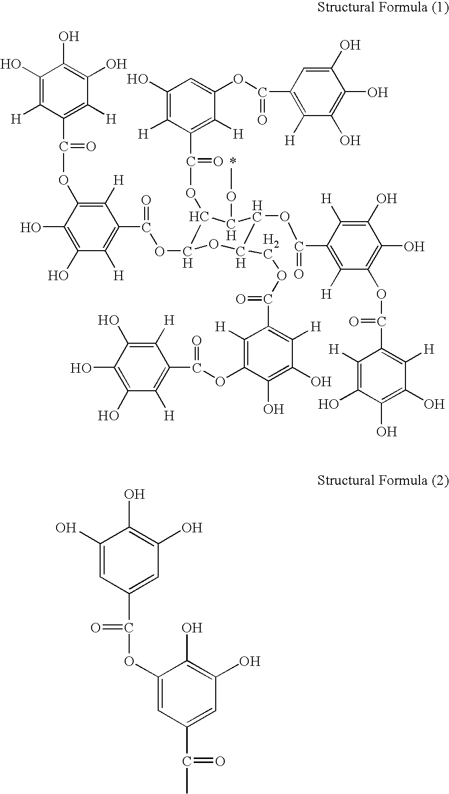

Catechins are compounds represented by the following Structural Formula (3). Quebracho tannin is a compound represented by the following Structural Formula (4). Turkish tannin is a compound represented by the following Structural Formula (5).

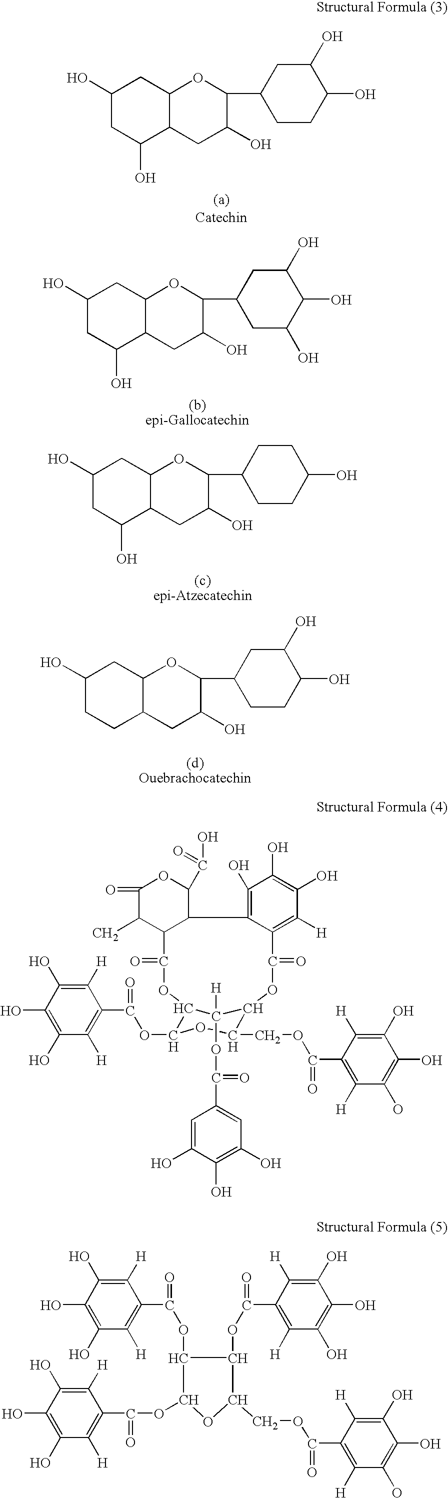

The dehydrated condensation tannin is a compound in which the above-noted tannin is dehydrated and condensed by heating at 70° C. to 230° C. for few minutes to several hours. On average approx. 1.6 molecules of the heated tannin are bounded each other accompanied by dehydration reactions. The binding occurs typically between tannin molecules, however, it is believed that water in one molecule is dehydrated by two adjacent hydroxyl groups in the molecule. The tannin is preferably the one with some tannin molecules dehydrated, condensed, and polymerized by heating it at 70° C. to 230° C. In this case, the tannin needs only be dehydrated to some extent and may not be necessarily condensed and polymerized.

Here, the word dehydrated condensation polymerization tannins is the name for tannins which have been subjected to heat treatment, and the word condensation polymerizable tannins indicates a structural type of tannin and is the name for categorization. These words differ from each other.

A polyvalent phenol compound having dye-fixing effect and tannage effect is referred to as synthesized tannin or syntan. Synthesized tannins are also effectively used in the present invention.

The tannins are used for commodities such as ink; pharmaceuticals such as homeostatic agents; and industrial products such as tanning agents and dye mordant used in dyeing. Recently, they are also used for food additives.

The polyvalent phenol compounds are recognized to be preferably compatible with polycarbonates (PC) which have a carbonate bond having a structure approximate to polyethylene terephthalate (PET) and polybutylene terephthalate (PBT) which are thermoplastic polyester resins; or polyester resins, and satisfactory transparency can be obtained even when added to these thermoplastic polyester resins.

—Saccharide Compound—

The saccharide compounds are contained in plant of nature, and examples thereof include monosaccharides, disaccharides, oligosaccharides, and polysaccharides. The saccharide compound may be extracted from natural plant, synthesized one, or a mixture thereof. Each of these may be used alone or in combination with two or more.

Examples of the monosaccharides include glucose or grape sugar, fluctose or fruit sugar, galactose, and mannose.

Examples of the disaccharides include maltose or malt sugar, sucrose or cane sugar, cellobiose, and lactose.

The oligosaccharides are so-called minor saccharide in which approx. three to ten monosaccharides mentioned above are bounded each other.

Examples of the polysaccharides include starch and cellulose.

Among these saccharides, at least one selected from glucose, fluctose, sucrose, and maltose is particularly preferable.

In recent years, monosaccharides are also produced by hydrolysis with a sulfuric acid catalyst of cellulose. These monosaccharides are preferably used in the present invention where they are used as additives to a resin because they are economical in terms of cost and can be refined with high purity.

The saccharide compounds exist as important substances such as food selves, drinking water and seasoning or flavoring. Various types of oligosaccharides or the like are synthesized, and they are available at relatively low cost and important compounds.

—Fatty Acid Compound—

The fatty acid compound is not particularly limited, may be suitably selected in accordance with the intended use, and preferably an organic carboxylate.

Examples of the organic carboxylic acid in the organic carboxylate include lower fatty acids such as sodium formate, and sodium acetate; higher fatty acids such as stearic acid, palmitic acid, and lauric acid; organic dicarboxylic acids such as oxalic acid, malonic acid, and succinic acid; and organic tricarboxylic acids such as citric acid.

Examples of salts in the organic carboxylate include, sodium, potassium, and calcium, of which sodium and potassium are particularly preferable from the perspective of economical efficiency.

Examples of the organic carboxylate include sodium lauric acid, potassium lauric acid, calcium acetate, sodium oxalate, and sodium ascorbate.

In the flame retardant agent, the mixture mass ratio of the polyvalent phenol compound, the saccharide compound, and the fatty acid compound or the polyvalent phenol compound: the saccharide compound: the fatty acid compound is preferably 1:0.1:0.1 to 1:50:10, more preferably 1:0.5:0.5 to 1:20:5, and still more preferably 1:0.5:0.2 to 1:20:2. When the mixed amount of the polyvalent phenol compound is so small, flame-retardant effect may not be obtained. While the polyvalent phenol is added in excess in a resin, physical properties of the resin may degrade.

When the mixed amount of the saccharide compound is so small, similarly, flame-retardant effect may not be obtained. While the saccharide compound is added in excess in a resin, forming properties of the resin may degrade. When the mixed amount of the fatty acid compound is so small, similarly, flame-retardant effect may not be obtained. While the fatty acid compound is added in excess in a resin, lowered physical properties and degraded forming properties of the resin may be observed.

(Flame-Retardant Resin Composition)

A flame-retardant resin composition according to the present invention comprises a resin and the flame retardant agent of the present invention and further comprises other components in accordance with the necessity.

The resin is not particularly limited and may be suitably selected in accordance with the intended use, for example, thermoplastic resin or the like are preferable. Each of these resins may be included alone or in combination with two or more.

The thermoplastic resin is not particularly limited and may be suitably selected from those known in the art in accordance with the intended use, and polyester resins are preferably used. Examples of the polyester resin include polycarbonate (PC) resins each of which have a carbonate bond having a structure approximate to polyethylene terephthalate (PET) resins and polybutylene terephthalate (PBT) resins or polyester resins. Each of these may be used alone or in combination of two or more.

As the flame retardant agent, a flame retardant agent according to the present invention is used.

The added amount of the flame retardant agent of the present invention to a resin is preferably 0.001 parts by mass to 5.0 parts by mass, more preferably 0.01 parts by mass to 1.0 part by mass relative to 100 parts by mass of the resin. When the added amount is so small, there may be difficulty in imparting sufficient flame retardance to a resin. While the flame retardant agent is added in excess to a resin, a large amount of the flame retardant agent resides between the molecules of the resin, and thermal properties and mechanical strength of the resin may degrade.

The method for adding the flame retardant agent to a resin is not particularly limited and may be suitably selected in accordance with the intended use. A powdered tannin compound, saccharides, and fatty acid salts may be mixed at the same time and directly added to a resin, or the flame retardant agent may be added to a resin by preparing a mixture of the flame retardant agent in which materials of the flame retardant agent have been preliminary mixed in the resin in high concentration.

Other components mentioned above are not particularly limited and may be suitably selected from known additives in the art which are used in flame-retardant resin compositions in accordance with the intended use, for example, glass fibers which are inorganic fibers, carbon fibers, or whiskers may be included in the flame-retardant resin compound. For organic fibers, Kepler fibers or the like may be included. The flame-retardant resin compound may also include inorganic particles of minerals such as silicas, talcs, micas, wallastonites, clays, and calcium carbonates. Further, antibacterial agents or the like may be mixed therein in accordance with the necessity.

These components can be used in a suitably selected amount not impairing the effects of the invention and may be used alone or in combination of two or more.

The method for forming the flame-retardant resin composition is not particularly limited and may be suitably selected from those in the art in accordance with the intended use. There are methods such as film-forming, extrusion-forming, injection-forming, blow-forming, compression-forming, transfer-forming, calendar-forming, heat-forming, flow-forming, and lamination-forming.

Since the flame-retardant resin compound of the present invention excels in flame retardance and formability, it can be formed into a variety of forms formed in various shapes, structures, and sizes and can be widely used as component parts in a variety of home electric appliances and office automation equipment such as personal computers, printers, television sets, stereo sets, copiers, air conditioners, refrigerators, and laundry machines.

According to the present invention, it is possible to provide a flame retardant agent enabling resolving various conventional problems, imparting high flame retardance with a small amount thereof without impairing basic physical properties of resins as well as being highly safe and harmless to humans and environment without substantially having negative effect thereon, because no halogen element and phosphorus element is contained in the flame retardant agent as well as to provide a flame-retardant resin composition which comprises the flame retardant agent.

Hereinafter, the present invention will be described referring to examples, however, the present invention is not limited to the disclosed examples.

### EXAMPLE 1

—Preparation of Flame-Retardant Polyester Resin Composition—

The first-class reagent of Chinese tannin (manufactured by Nacalai Tesque, Inc.) was used for a polyvalent phenol compound. For a saccharide compound, a commercially available white sugar i.e. sucrose (manufactured by Nisshin Sugar Manufacturing Co., Ltd.), was used. For a fatty acid compound, i.e. organic acid salt, sodium lauric acid (manufactured by Lion Corporation) was used. These compounds were respectively added at the ratios shown in Table 1 to 100 parts by mass of a polyethylene terephthalate (PET) resin (Mistui PETJ120 manufactured by Mitsui Chemicals, Inc.) to prepare flame-retardant polyester resin compositions with lot numbers 1 to 7.

### COMPARATIVE EXAMPLE 1

—Preparation of Polyester Resin Composition—

A polyester resin composition with lot number 8 was prepared in the same manner as Example 1, provided that all the compounds of Chinese tannin as a polyvalent phenol compound, white sugar or sucrose as a saccharide compound, and sodium lauric acid as a fatty acid compound or an organic acid salt were not added to the polyethylene terephthalate (PET) resin.

### COMPARATIVE EXAMPLE 2

—Preparation of Polyester Resin Composition—

A polyester resin composition with lot number 9 was prepared in the same manner as Example 1, provided that 0.10 parts by mass of Chinese tannin as a polyvalent phenol compound was only added to the polyethylene terephthalate (PET) resin.

### COMPARATIVE EXAMPLE 3

—Preparation of Polyester Resin Composition—

A polyester resin composition with lot number 10 was prepared in the same manner as Example 1, provided that 0.05 parts by mass of white sugar as a saccharide compound was only added to the polyethylene terephthalate (PET) resin.

### COMPARATIVE EXAMPLE 4

—Preparation of Polyester Resin Composition—

A polyester resin composition with lot number 11 was prepared in the same manner as Example 1, provided that 0.05 parts by mass of carboxylate a fatty acid compound or an organic acid salt was only added to the polyethylene terephthalate (PET) resin.

TABLE 1

| | | Polyvalent | | Organic Acid |
|---|---|---|---|---|
| | Lot | Phenol | Sucrose | Salt |
| | No. | (part by mass) | (part by mass) | (part by mass) |
| Example 1 | 1 | 0.05 | 0.1 | 0.1 |
| | 2 | 0.05 | 0.1 | 0.05 |
| | 3 | 0.05 | 0.5 | 0.05 |
| | 4 | 0.05 | 1.0 | 0.05 |
| | 5 | 0.1 | 0.1 | 0.05 |
| | 6 | 0.2 | 0.1 | 0.05 |
| | 7 | 0.3 | 0.1 | 0.05 |
| Compara. | 8 | Not added | Not added | Not added |
| Ex. 1 | | | | |
| Compara. | 9 | 0.1 | Not added | Not added |
| Ex. 2 | | | | |
| Compara. | 10 | Not added | 0.05 | Not added |
| Ex. 3 | | | | |
| Compara. | 11 | Not added | Not added | 0.05 |
| Ex. 4 | | | | |

<Combustion Test>

Next, combustion tests were performed as described below for the obtained each flame-retardant polyester resin composition and each polyester resin composition.

First, a given amount of respective resin compositions were dried in a dehumidifying dryer (PO-200 manufactured by MATSUI MANUFACTURING Co., Ltd.) at 110° C. for 10 hours and then stirred and mixed using a tumbler (Tumbling Mixer TM-50 having 8 mixing fans manufactured by Nissui Corp.) at a rotation speed of the mixing fans approx. 300 rpm for 4 minutes. The mixed resin compound was placed in an injection molding machine (F-85 with a clamping pressure of 85 ton manufactured by Klockner Werke AG) and formed and shaped using a mold designed so as to be able to take combustion test samples having a thickness represented by the UL-94 Flame Retardant Standard to thereby prepare the samples at the same time. Lot numbers of the samples are same as those shown in Table 1.

The obtained samples were respectively subjected to a combustion test in accordance with the vertical firing of the UL-94 Flame Retardant Standard. The combustion time is the sum of those of five samples. Table 2 shows the results.

TABLE 2

| | | Thickness | Combustion Time (sec) | | |
|---|---|---|---|---|---|
| | | of | First | Second | Sum of |
| | Lot | Sample | Combustion | Combustion | Combustion |
| | No. | (mm) | time | time | Time |
| Example 1 | 1 | 1.59 | 3 | 7 | 10 |
| | 2 | 1.58 | 2 | 6 | 8 |
| | 3 | 1.59 | 4 | 7 | 11 |
| | 4 | 1.59 | 3 | 4 | 7 |
| | 5 | 1.58 | 2 | 3 | 5 |
| | 6 | 1.59 | 4 | 4 | 8 |
| | 7 | 1.59 | 4 | 6 | 10 |
| Compara. | 8 | 1.59 | 31 | 46 | 77 |
| Ex. 1 | | | | | |
| Compara. | 9 | 1.59 | 10 | 29 | 39 |
| Ex. 2 | | | | | |
| Compara. | 10 | 1.59 | 14 | 25 | 39 |
| Ex. 3 | | | | | |
| Compara. | 11 | 1.59 | 17 | 31 | 48 |
| Ex. 4 | | | | | |

The results shown in Tables 1 and 2 demonstrated that the sum of combustion time of the polyester resin compositions of Comparative Examples 2 to 4 in which one compound selected from the polyvalent phenol compound, the saccharide compound, and the fatty acid compound had been respectively added was reduced to approx. one-half compared to that of Comparative Example 1 in which none of the three compounds had been added to the polyester resin composition.

Correspondingly, the polyester resin compositions according to Example 1 respectively had an extremely excellent effect of reducing the combustion time as well as high flame retardance satisfying the UL-94 of Flame Retardant Standard compared to those of Comparative Examples 1 to 2 to 4.

### EXAMPLE 2

—Preparation of Flame-Retardant Polyester Resin Composition—

Flame-retardant polyester resin compositions with lot numbers 12 to 18 were prepared in the same manner as Example 1, provided that the first-class reagent of Chinese tannin (manufactured by Nacalai Tesque, Inc.) as a polyvalent phenol compound was replaced by a catechin (the first-class reagent, manufactured by KANTO CHEMICAL CO., IND.).

The obtained flame-retardant polyester resin compositions were respectively subjected to a combustion test in the same manner as Example 1. Table 3 shows the results.

TABLE 3

| | | Thickness | Combustion Time (sec) | | |
|---|---|---|---|---|---|
| | | of | First | Second | Sum of |
| | Lot | Sample | Combustion | Combustion | Combustion |
| | No. | (mm) | time | time | Time |
| Example 2 | 12 | 1.59 | 4 | 8 | 12 |
| | 13 | 1.59 | 2 | 7 | 11 |
| | 14 | 1.59 | 3 | 8 | 11 |
| | 15 | 1.59 | 3 | 7 | 10 |
| | 16 | 1.59 | 2 | 8 | 10 |
| | 17 | 1.59 | 4 | 5 | 9 |
| | 18 | 1.59 | 3 | 5 | 8 |

The results shown in Table 3 demonstrated that the flame-retardant polyester resin compositions respectively had flame retardance as high as Example 1 even when Chinese tannin used as a polyvalent phenol compound in Example 1 was replaced by catechin.

### EXAMPLE 3

—Preparation of Flame-Retardant Resin Composition—

Flame-retardant resin compositions with lot numbers 19 to 22 were prepared in the same manner as lot numbers 1 to 2 of Example 1, provided that polyethylene terephthalate (PET) resin was replaced by a polycarbonate (PC) resin (Panlight L 1250Y manufactured by TEIJIN CHEMICALS LTD.) and a polybutylene terephthalate (PBT) resin (Duranex 2000 manufactured by WinTech Polymer Ltd.).

The obtained flame-retardant resin compositions were respectively subjected to a combustion test in the same manner as Example 1. At the same time, the combustion tests of the flame-retardant resin compositions in which each of the polycarbonate (PC) resin and the polybutylene terephthalate (PBT) resin had not been added were performed. Table 4 shows the results.

TABLE 4

| | | | | Combustion Time (sec) | | |
|---|---|---|---|---|---|---|
| | | | Thick- | First | Second | Sum of |
| | | | ness of | Combus- | Combus- | Combus- |
| | | Lot | Sample | tion | tion | tion |
| | | No. | (mm) | time | time | Time |
| Exam- | PC | 19 | 1.59 | 11 | 13 | 25 |
| ple 3 | | | | | | |
| | | 20 | 1.59 | 8 | 16 | 24 |
| | PC Not added | | 1.59 | 27 | 60 | 87 |
| | PBT | 21 | 1.59 | 15 | 16 | 31 |
| | | 22 | 1.59 | 9 | 11 | 20 |
| | PBT | Not | 1.59 | 26 | 45 | 71 |
| | | | added | | | |

The results shown in Table 4 demonstrated that these flame-retardant resin compositions were respectively able to shorten the combustion time as much as Example 1 even when the polyethylene terephthalate (PET) resin was replaced by the polycarbonate (PC) and the polybutylene terephthalate (PBT) resin.

### EXAMPLE 4

—Preparation of Flame-Retardant Polyester Resin Composition—

Various flame-retardant polyester resin compositions were prepared in the same manner as Example 1, provided that the flame retardant agent in which the first-class reagent of Chinese tannin:the sucrose:the sodium lauric acid were mixed at a mass ratio of 2:4:1, and the added amount of the flame retardant agent relative to 100 parts by mass of polyethylene terephthalate (PET) was changed to 0 part by mass to 10 parts by mass.

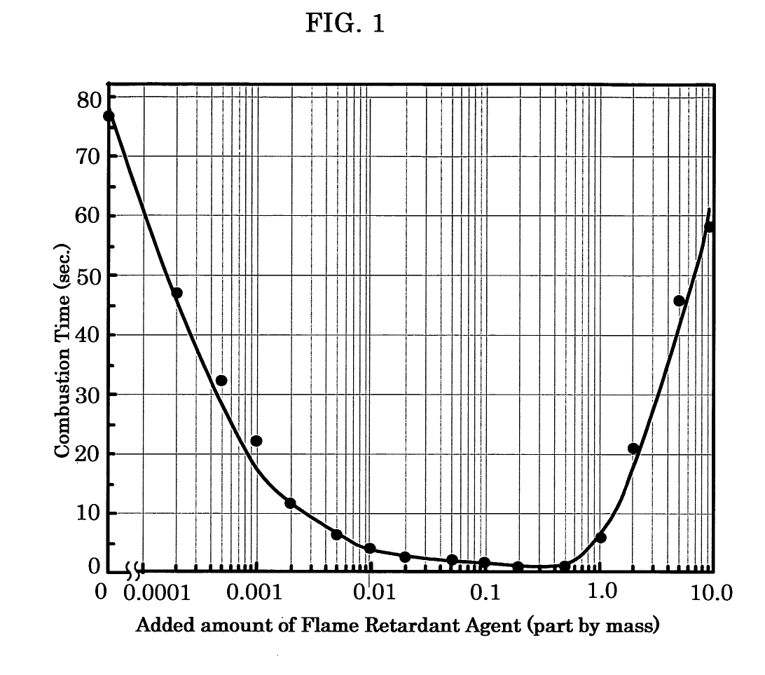

The obtained flame-retardant polyester resin compositions were subjected to a combustion test in the same manner as Example 1. FIG. 1 shows the result.

The result shown in FIG. 1 demonstrated that the combustion time was substantially shorten by adding the flame retardant agent, and proved that addition of the flame retardant agent was remarkably effective in reducing the combustion time.

### EXAMPLE 5

—Preparation of Flame-Retardant Polyester Resin Composition—

A flame-retardant polyester resin composition with lot number 23 was prepared in the same manner as lot number 1 in Example 1, provided that glucose (the first-class reagent, manufactured by Nacalai Tesque, Inc.) was used instead of the sucrose.

The combustion time of the obtained flame-retardant polyester resin composition was measured in the same manner as Example 1. Table 5 shows the result.

TABLE 5

| | | | | Combustion Time (sec) | | |
|---|---|---|---|---|---|---|
| | | | Thick- | First | Second | Sum of |
| | | | ness of | Combus- | Combus- | Combus- |
| | Lot | | Sample | tion | tion | tion |
| | No. | Additive | (mm) | time | time | Time |
| Exam- | 23 | Glucose | 1.59 | 3 | 7 | 10 |
| ple 5 | | | | | | |

### EXAMPLE 6

—Preparation of Flame-Retardant Polyester Resin Composition—

Flame-retardant polyester resin compositions with lot number 24 to 27 were prepared in the same manner as lot number 2 in Example 1, provided that a potassium lauric acid, a calcium acetate, a sodium oxalate, and a sodium ascorbate were used instead of the sodium lauric acid.

For the obtained flame-retardant polyester resin compositions, the combustion time was measured in the same manner as Example 1. Table 6 shows the results.

TABLE 6

| | | | | Combustion Time (sec) | | |
|---|---|---|---|---|---|---|
| | | | Thick- | First | Second | Sum of |
| | | | ness of | Combus- | Combus- | Combus- |
| | Lot | | Sample | tion | tion | tion |
| | No. | Additive | (mm) | time | time | Time |
| Exam- | 24 | Potassium | 1.59 | 2 | 9 | 11 |
| ple 6 | | lauric acid | | | | |
| | 25 | Sodium | 1.59 | 5 | 9 | 14 |
| | | oxalate | | | | |
| | 26 | Calcium | 1.59 | 4 | 10 | 14 |
| | | acetate | | | | |
| | 27 | Sodium | 1.59 | 3 | 6 | 9 |
| | | ascorbate | | | | |

The results shown in Tables 5 and 6 demonstrated that combustibleness of resins can be effectively suppressed by adding a flame retardant agent which comprises a polyvalent phenol compound, a saccharide compound, and a fatty acid compound to a resin, and such flame-retardant resin compositions satisfy the UL-94 Flame Retardant Standard.

A flame retardant agent of the present invention comprises a polyvalent phenol compound, a saccharide compound, and a fatty acid compound and enables imparting excellent flame retardance when the flame retardant agent is added to resins, in particular, to polyester resins.

A flame-retardant resin composition with the flame retardant agent of the present invention added thereto satisfies the UL-94 Flame Retardant Standard and is suitably used for a variety of component parts of home electric appliances and office automation equipment.

What is claimed is:

1. A flame retardant agent comprising:
a polyvalent phenol compound, a saccharide compound, and a fatty acid compound.

2. The flame retardant agent according to claim 1, wherein the polyvalent phenol compound is a tannin compound.

3. The flame retardant agent according to claim 2, wherein the tannin compound comprises any one selected from tannins, dehydrated condensation polymer compounds of tannins, tannic acids, catechins, leucoanthocyanes, and chlorogenic acids.

4. The flame retardant agent according to claim 1, wherein the saccharide compound comprises any one selected from monosaccharides, disaccharides, oligosaccharides, and polysaccharides.

5. The flame retardant agent according to claim 4, wherein the saccharide compound is at least one selected from glucoses, fructoses, sucroses, and maltoses.

6. The flame retardant agent according to claim 1, wherein the fatty acid compound comprises an organic carboxylate.

7. The flame retardant agent according to claim 6, wherein the organic carboxylate is at least one selected from sodium lauric acids, potassium lauric acids, calcium acetates, sodium oxalates, and sodium ascorbates.

8. The flame retardant agent according to claim 1, wherein the mixture mass ratio of the polyvalent phenol compound, the saccharide compound, and the fatty acid compound is 1:0.1:0.1 to 1:50:10.

9. A flame-retardant resin composition comprising:
a resin, and
a flame retardant agent,
wherein the flame retardant agent comprises a polyvalent phenol compound, a saccharide compound, and a fatty acid compound.

10. The flame-retardant resin composition according to claim 9, wherein the resin is a thermoplastic resin, and the thermoplastic resin is a polyester resin.

11. The flame-retardant resin composition according to claim 10, wherein the polyester resin is at least one selected from polyethylene terephthalates, polybutylene terephthalates, and polycarbonates.

12. The flame-retardant resin composition according to claim 9, wherein the added amount of the flame retardant agent is 0.001 parts by mass to 5.0 parts by mass relative to 100 parts by mass of the resin.
